(19) United States
(12) Patent Application Publication
(10) Pub. No.: US 2024/0403028 A1
(43) Pub. Date: Dec. 5, 2024

(54) MULTI-FUNCTIONAL COMPUTERIZED CHARGING STATION FOR ELECTRIC VEHICLES

(71) Applicant: B.G. NEGEV TECHNOLOGIES AND APPLICATIONS LTD., AT BEN-GURION UNIVERSITY, BEER-SHEVA (IL)

(72) Inventor: Mordechai GURI, NOF AYALON (IL)

(21) Appl. No.: 18/699,790

(22) PCT Filed: Oct. 6, 2022
(86) PCT No.: PCT/IL2022/051068

§ 371 Date: Apr. 9, 2024

Related U.S. Application Data
(60) Provisional application No. 63/254,121, filed on Oct. 10, 2021.

(51) Int. Cl. G06F 8/65; B60L 53/18; B60L 53/66; B60L 53/68

(52) U.S. Cl. CPC G06F 8/65; B60L 53/18; B60L 53/66; B60L 53/68; B60L 2210/30; B60L 2250/30

(57) ABSTRACT

A charging system for Electric Vehicles (EVs), comprising an AC/DC charger; an AC/DC charging cable being connected to the battery of an EV, to be charged, via an adaptor in the EV, for charging the battery or other electric components of the EV with AC or DC power, or both; a data exchange interface, added to the charging cable, and being connected to predetermined computerized subsystems of the EV; a data connection to a remote computation cloud and/or to remote serves, which are equipped with dedicated software for connecting to the EV via the data exchange interface and performing remote operations and data exchange with computerized subsystems of the EV according to predetermined credentials and communication protocols.

### FIELD OF THE INVENTION

The present invention relates to the field of electric vehicles. More particularly, the invention relates to a computerized charging interface for protecting, monitoring, and updating Electric Vehicles (EVs).

### BACKGROUND OF THE INVENTION

Modern Electric Vehicles (EVs) such as electric cars, Unmanned Aerial Vehicle (UAVs), electric trucks, electric scooters, electric bicycles and drones are being charged on a regular basis, as their traveling range is limited, where charging is done via their connecting interface. For example, a charging station, also called an EV charger or Electric Vehicle Supply Equipment (EVSE), is equipment that supplies electrical power for fast charging plug-in electric vehicles (including hybrid vehicles, Neighborhood Electric Vehicles, trucks, buses, and others).

Low-power public charging stations (also known as “AC charging stations”) are able to provide AC power. High power charging stations allow faster charging but require much larger AC-to-DC converters. These converters are integrated into the charging station, rather than into the vehicle, and the charging station supplies already-converted DC power directly to the vehicle, while bypassing the vehicle's onboard converter. These types of charging stations are known as “DC charging stations”. Most of the modern electric cars can be charged both by AC and DC power.

Charging stations provide connectors that are compatible with a variety of standards to match different EVs. DC charging stations are usually equipped with multiple connectors, to be able to supply power to a wide variety of vehicles.

One existing method is Autocharge, which is a user-friendly authorization method, where the EV is authorized using its vehicle ID. When the EV is connected to the charging station with the charging cable, the EV sends its Media Access Control (MAC) address to the charging station. The charging station uses an Open Charge Point Protocol (OCPP) request to send the data to the Charging Station Management System (CSMS) where the address is matched with an address list. A successful match sends an authorization response back to the charging station and an unsuccessful match sends an error state. However, Autocharge is mostly used in closed charging depots rather than at public charging stations, due to security concerns.

Another existing method is the Plug and Charge (P&C), which effectively streamlines the EV charging process. Instead of using a credit card, presenting an RFID tag, or using a mobile application, EV owners only need to connect their vehicle to the charge point—via cable for AC and DC charging vehicles or Wi-Fi for wireless charging. During a Plug & Charge session, security must be maintained as the transaction, information about the vehicle and owner, the billing details, and the charging network all need to be protected from third-party manipulation. ISO 15118's standards ensure this is done using encryption, decryption, and two-way authentication. Plug & Charge uses cryptographic tools to secure communications between the vehicle and the charging infrastructure, protecting the driver's personal information, the vehicle's systems that are “touched” during the charging process and the charging infrastructure, from malicious third-party actors during the charging process. Once the vehicle-charge point connection is made, all identification and authorization happen across a highly secure communications link, to ensure data is exchanged in a confidential and authenticated way.

Each vehicle is linked to an individual billing account, whether personal, family, corporate, or other EV owners. Authentication standards allow the EV to automatically identify itself to the charging network and have the backend system “issue” validation, and then begin the charge. The transaction will be accurately documented to reflect the energy that was supplied to the EV. This way, the Plug and Charge authorization technique only requires the driver to plug the charging cable into the EV and the EV will be automatically identified and authorized to charge. The method works with an asymmetric key algorithm, that uses a key pair with a private and a public key. Both keys are linked in such a way that an encrypted message can only be decrypted with the corresponding key. The implementation of the Public Key Infrastructure (PKI) and the certificate handling are required.

Standards such as IEC 61851 allow basic information on the charging process to be exchanged. For example, the ISO 15118 standard is based on IEC 61851 and supplements it with digital communication via Powerline. This makes it possible to exchange more complex information such as the vehicle's charging status and battery capacity, tariffs, and charging schedules. The primary function enabled by the standard is so-called “smart charging”. The security of the standard is based on various encryption schemes such as Transport Layer Security (TLS) and the matching of digital certificates that originate from a Grid Root Certificate Authority (Root CAs).

However, all the above EV charging methods have only limited ability of data exchange and are mainly directed to the charging process itself, while failing to exchange data regarding the state of the vehicle from its technical aspects and its cyber security aspects. Also, the above methods do not provide a satisfactory solution to the problem of diagnosis and maintenance of the vehicle's sub-systems during the charging period.

It is therefore an object of the present invention to provide a computerized charging interface for protecting Electric Vehicles (EVs) against cyber-attacks during the charging period.

It is another object of the present invention to provide a computerized charging interface for monitoring the state of Electric Vehicles (EVs) during the charging period and when required, updating software modules for the Electric Vehicles (EVs) before ending the charging process.

It is a further object of the present invention to provide a computerized charging interface for allowing online diagnosis and maintenance of the vehicle's sub-systems during the charging period.

Other objects and advantages of the invention will become apparent as the description proceeds.

### SUMMARY OF THE INVENTION

A charging system for Electric Vehicles (EVs), comprising:
a) an AC/DC charger;
b) an AC/DC charging cable being connected to the battery of an EV, to be charged, via an adaptor in the EV, for charging the battery or other electric components of the EV with AC or DC power, or both;
c) a data exchange interface, added to the charging cable, and being connected to predetermined computerized subsystems of the EV; and
d) a data connection to a remote computation cloud and/or to remote serves, which are equipped with dedicated software for connecting to the EV via the data exchange interface and performing remote operations and data exchange with computerized subsystems of the EV according to predetermined credentials and communication protocols.

The computerized subsystems of the EV may be selected from the group of:
the EV's computer;
the EV's internal computer system(s);
the EV's internal embedded system(s) or controller(s);
the EV's infotainment system(s);
the EV's navigation system(s).

The data exchange interface allows one or more of the following:
access to firmware and operating software of the internal components of the EV via dedicated interfaces deployed in the EV;
extraction of information and logs from the internal components of the EV;
update firmware;
update software;
update the operating system;
update data files or configuration files in the internal components of the EV;
perform full or incremental backup of the file system to an offline or online storage medium;
perform malware scans of the file systems of internal computerized components;
perform integrity checks of the firmware, operating systems and file systems of internal computerized components;
perform full or download of a firmware, operating system, file system or log files.

The storage medium may be integrated with the charger, or inserted into a socket in the charger, as external storage.

Scanning of the firmware may be performed at the application level and at the OS level. The backup may include image extraction of the EV and its internal subsystems.

In one aspect, after malware scan, the user receives warnings and alerts regarding malicious findings.

The dedicated software may be adapted to:
delete malicious files;
block operations of malicious files;
cleaning malicious applications;
perform updates of internal encryption keys, certificates, or other security tokens of the internal components of the EV is performed;
update of bootloaders and/or other firmware, software and/or applications files and images during charging;
perform scanning and/or integrity check on bootloaders and/or other firmware level images;
update encryption keys, codes, credentials, certificates or security tokens;
use security token transferred to the vehicle;
upon connection to the charger, validate the token against the EV;
if the token is unknown, lock the EV according to the policy of locking the vehicles, as defined by the servers.

The data exchange interface allows connection to the internal components of the EV, to be used as a debugging interface and scanning the memory for malware and also allows access to the low-level storage information from a boot-loader, kernel and operating system, to perform forensic investigation and backups.

Scanning may be based on signature databases, static analysis, dynamic analysis, and heuristic methods.

The protocols passing via the interface of the electric charger may be intercepted, monitored and analyzed with databases, static analysis, dynamic analysis, and heuristic methods.

The data exchange interface also allows connection to the internal components of the EV and access to logs of the internal components, to extract data from the logs and to send the extracted data to servers or cloud, for further analysis.

The charging system may further comprise a user interface being connected to the charger, for allowing displaying messages to the user and receiving inputs from the user.

The interface may include a loudspeaker for outputting messages or alerts to the user, a microphone for receiving audio inputs from the user, and biometric sensors for authenticating the identity of the user.

The charging system may further comprise cellular, Wi-Fi or Bluetooth networking capabilities.

The dedicated software may be used for:
transferring storage content between two vehicles;
copying and moving data to other vehicles or other charging systems.

The EV may be selected from the group of:
Electric vehicles;
UAVs;
Drones;
Electric trucks;
Scooters;
Electric bicycles.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates a smart charging system with a computerized charging interface for protecting, monitoring, and updating Electric Vehicles (EVs), according to an embodiment of the invention; and

FIG. 2 shows an EV which may be connected to various chargers, according to IEC standards.

### DETAILED DESCRIPTION OF THE INVENTION

A charging infrastructure usually consists of the electric vehicle, the charging station and the Charging Station Management System (CSMS). A charging station is a physical structure in which an electric vehicle can be charged.

For example, ISO 15118 is an international standard for charging electric vehicles including bi-directional digital communications between electric vehicles and the charging station. ISO 15118 is focused on securing the future of vehicle charging through the simplicity of use and defines a Vehicle-to-Grid (V2G) communication (a standard for the interactions between the Electric Vehicles and the grid) interface for bi-directional charging/discharging of electric vehicles. ISO 15118 is a key enabler of the Plug & Charge capability, allowing EV drivers to insert the charge plug into the car, charge, and drive away when ready. This process is enabled by a digital certificate located in the vehicle, which allows the vehicle to communicate with the Charging Point Management System (CPMS). This enables a seamless end-to-end charging process, which includes automatic authentication and billing, and avoids the need to use an RFID card, an application or to memorize PIN numbers. Specifications such as ISO 15118 govern the automated, secure exchange of information between the vehicle and the charging infrastructure, based on digital certificates. Once the connection between the vehicle and the charging station is established, the authorization data from the driver is transmitted and compared in encrypted form. After checking has been completed, the charging process starts automatically and the payment process is then carried out without any further action. Therefore, Plug & Charge via ISO 15118 enables secure authentication and authorization of a charging process for the first time, also available offline, where all that is required is to plug in the charging cable.

Each vehicle is linked to an individual billing account, whether personal, family, corporate, or other EV owners. Authentication standards allow the EV to automatically identify itself to the charging network and have the backend system “issue” validation, and then begin the charge. The transaction will be accurately documented to reflect the energy that was supplied to the EV.

At the initial phase of the charging of an EV, there is a potential authentication between the EV and the charging station. After the initial authentication, the charging process begins with a certain level of data exchange. There are several existing data exchanges between the EV and the station.

There are standards for the communication between electric vehicles and charging stations. Standards such as IEC 61851 allow basic information on the charging process to be exchanged. For example, the ISO 15118 standard is based on IEC 61851 and supplements it with digital communication via Powerline. This allows for exchanging more complex information such as the vehicle's charging status and battery capacity, tariffs, and charging schedules. The primary function enabled by the standard is so-called “smart charging”. The security of the standard is based on various encryption schemes such as Transport Layer Security (TLS) and the matching of digital certificates that originate from a Grid Root Certificate Authority (Root CAs).

The present invention provides a smart charging system with a computerized charging interface for protecting, monitoring, and updating Electric Vehicles (EVs—including, UAVs, drones, electric trucks, electric scooters and electric bicycles). This interface will be able to connect to devices with additional functionalities such as a file-system, and internal storage and to use the device functionalities during the charging period. In addition to a regular charger, the new charging system provides additional functionalities regarding the update, examination, analysis, maintenance, backup and security of the vehicle while being charged.

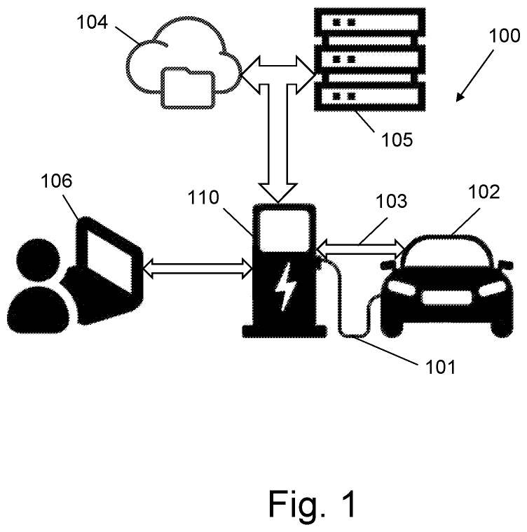

FIG. 1 illustrates a smart charging system with a computerized charging interface for protecting, monitoring, and updating Electric Vehicles (EVs), according to an embodiment of the invention. The smart charging system is based on a physical connection between the EV and an external station, such as a charging station. The charging interface is connected to the charging system by a wired or wireless connection and allows the update of software/firmware or extraction of information from the internal components of the EV.

Charging system 100 comprises an Alternating Current (AC)/Direct Current (DC) charger 110 and an AC/DC charging cable 101 (or any other suitable charging interface) which is connected to the battery of an EV 102 to be charged via a suitable adaptor in the EV. An additional data exchange interface 103 is added to the charging cable 101 and upon connecting the EV to the charger, is connected to predetermined computerized subsystems of the EV. The charging cable 101 is used to charge the battery or other electric components of the EV with AC or DC power, or both. The Charging system 100 is also connected, via data connection, to a remote computation cloud 104 and/or to remote serves 105, which are equipped with dedicated software for connecting to the EV 102 (via the data exchange interface 103) and performing remote operations and data exchange with computerized subsystems of the EV, such as the EV's computer, the EV's internal computer system(s), the EV's internal embedded system(s) or controller(s), the EV's infotainment system(s), the EV's navigation system(s) and other internal computerized subsystems, according to predetermined credentials and communication protocols. The protocols passing via the data exchange interface 103 may be intercepted, monitored and analyzed (e.g., using static analysis, dynamic analysis, and heuristic methods) with data from databases.

The data exchange interface 103 allows access to firmware and operating software of the internal components of the EV 102, via dedicated interfaces that are deployed by the manufacturer of the EV 102, as well as extraction of information and logs from the internal components of the EV 102. The data exchange interface 103 is adapted to update firmware, software, the operating system, data files, or configuration files in the internal components of the electric vehicle, if so desired, perform full or incremental backup of the file system to an offline or online storage medium, perform malware scans of the file systems of internal computerized components, perform integrity checks of the firmware, operating systems and file systems of internal computerized components, and perform full or download of a firmware, operating system, file system or log files. This saves the need to recall EVs to authorized garages or service points whenever updates are required.

According to another embodiment, a full or incremental backup of the file system to an offline storage medium is performed. The storage medium may be integrated with the charger 110, or inserted into a socket in the charger 110, as external storage (e.g., memory stick). Alternatively, backup of the file system may be performed to an online storage, residing on the computational cloud 104 or on the remote servers 105. In addition, malware scans of the file systems of internal computerized components may be performed, including scanning the firmware at the application level and at the OS level. Backup may include image extraction of the EV and its internal subsystems. Also, integrity checks of the firmware, operating systems and file systems of internal computerized components may be performed, as well as performing full scanning or downloading of a firmware, operating system, file system or log files. After a malware scan, the user may receive warnings and the dedicated software can delete malicious files, block their operations, clean the malicious applications, and perform updates.

According to another embodiment, an update of internal encryption keys, certificates, or other security tokens of the internal components of the EV is performed. Update of bootloaders and/or other firmware, software and/or applications files and images may be performed while charging.

According to another embodiment, the data exchange interface 103 allows connection to the internal components of the EV, to be used as a debugging interface and scanning the memory for malware or other predefined activities.

According to another embodiment, the data exchange interface 103 allows connection to the internal components of the EV and access to the low-level storage information from a boot-loader, kernel and operating system, so as to perform forensic investigation and backups. Scanning may be based on signature databases, static analysis, dynamic analysis, heuristic methods and so on. Connection to the vehicle allows scanning and/or integrity check on bootloaders and/or other firmware-level images.

According to another embodiment, the data exchange interface 103 allows connection to the internal components of the EV and access to logs of the internal components, to extract data from the logs and to send the extracted data to servers 105 or cloud 104, for further analysis.

According to another embodiment, the charging system 100 may include a user interface 106, that is connected to the charger 110, for allowing the intervention of the user via a screen (e.g., an external screen or a touch screen) and a keypad, a keyboard or a touch screen that interact with the user, display messages and receive inputs from the user. The interface 106 might be integrated or added to the electric charging interface of the EV 102, or is as an additional interface. user interface 106 may include a loudspeaker for outputting messages or alerts to the user, a microphone for receiving audio inputs from the user, and biometric sensors for authenticating the identity of the user. After malware scan, the user can receive warnings and alerts regarding malicious findings.

According to another embodiment, the charging system 100 may include networking capabilities, such as Cellular, Wi-Fi and Bluetooth.

According to another embodiment, the charging system 100 and dedicated software may update encryption keys, codes, credentials, certificates or security tokens. The system may use a security token transferred to the vehicle. Upon connection to the charger 110, the token will be validated against the vehicle. If the token is unknown, the vehicle will be locked according to the policy of locking the vehicle, as defined at by the servers 105.

According to another embodiment, the charging system 100 and dedicated software may be used for transferring storage content between two vehicles, as well as copying and moving data to other vehicles or other charging systems.

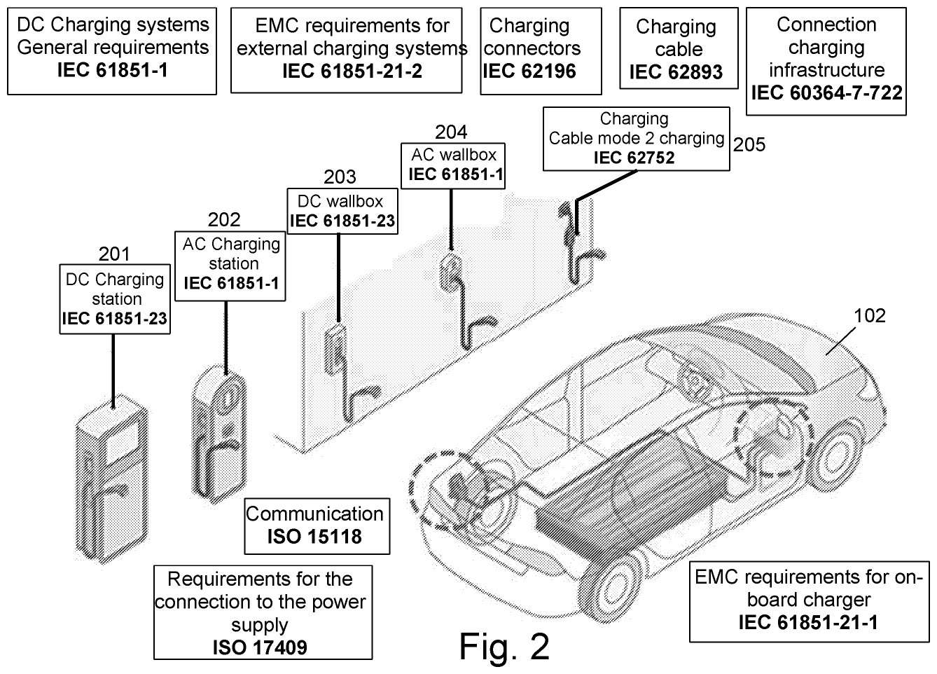

FIG. 2 shows an EV 102 which may be connected to various chargers, such as a DC charging station 201, an AC charging station 202, a DC wallbox 203, an AC wallbox 204 or to a charging cable node 205, according to IEC standards 61851-23, 61851-1 and 62752. Each of the various chargers may be used as charger 102, to implement the Charging system 100 provided by the present invention.

As various embodiments and examples have been described and illustrated, it should be understood that variations will be apparent to one skilled in the art without departing from the principles herein. Accordingly, the invention is not to be limited to the specific embodiments described and illustrated in the drawings.

1. A charging system for Electric Vehicles (EVs), comprising:
a) an AC/DC charger;
b) an AC/DC charging cable being connected to the battery of an EV, to be charged, via an adaptor in said EV, for charging said battery or other electric components of said EV with AC or DC power, or both;
c) a data exchange interface, added to said charging cable, and being connected to predetermined computerized subsystems of said EV; and
d) a data connection to a remote computation cloud and/or to remote server, which are equipped with dedicated software for connecting to said EV via said data exchange interface and performing remote operations and data exchange with computerized subsystems of said EV according to predetermined credentials and communication protocols.

2. The charging system according to claim 1, wherein the computerized subsystems of the EV are selected from the group of:
the EV's computer;
the EV's internal computer system(s);
the EV's internal embedded system(s) or controller(s);
the EV's infotainment system(s); and
the EV's navigation system(s).

3. The charging system according to claim 1, wherein the data exchange interface allows one or more of the following:
access to firmware and operating software of the internal components of said EV via dedicated interfaces deployed in said EV;
extraction of information and logs from the internal components of said EV;
update firmware;
update software;
update the operating system;
update data files or configuration files in the internal components of said EV;
perform full or incremental backup of the file system to an offline or online storage medium;
perform malware scans of the file systems of internal computerized components;
perform integrity checks of the firmware, operating systems and file systems of internal computerized components; and
perform full or download of a firmware, operating system, file system or log files.

4. The charging system according to claim 1, wherein the storage medium is integrated with the charger, or inserted into a socket in said charger, as external storage.

5. The charging system according to claim 1, wherein scanning of the firmware is performed at the application level and at the OS level.

6. The charging system according to claim 3, wherein the backup includes image extraction of the EV and its internal subsystems.

7. The charging system according to claim 3, wherein after malware scan, the user receives warnings and alerts regarding malicious findings.

8. The charging system according to claim 1, wherein the dedicated software is adapted to:
delete malicious files;
block operations of malicious files;
cleaning malicious applications;
perform updates of internal encryption keys, certificates, or other security tokens of the internal components of the EV is performed;
update of bootloaders and/or other firmware, software and/or applications files and images during charging;
perform scanning and/or integrity check on bootloaders and/or other firmware level images;
update encryption keys, codes, credentials, certificates or security tokens;
use security token transferred to the vehicle;
upon connection to the charger validate said token against the EV;
if the token is unknown, lock said EV according to the policy of locking the vehicles, as defined by the servers.

9. The charging system according to claim 1, wherein the data exchange interface allows connection to the internal components of the EV, to be used as a debugging interface and scanning the memory for malware.

10. The charging system according to claim 1, wherein the data exchange interface allows connection to the internal components of the EV and access to:
the low-level storage information from a boot-loader, kernel and operating system, to perform forensic investigation and backups;
logs of the internal components, to extract data from the logs and to send the extracted data to servers or cloud, for further analysis.

11. The charging system according to claim 3, wherein scanning is based on signature databases, static analysis, dynamic analysis, and heuristic methods.

12. The charging system according to claim 3, wherein the protocols passing via the interface of the electric charger are intercepted, monitored and analyzed with databases, static analysis, dynamic analysis, and/or heuristic methods.

13. The charging system according to claim 1, wherein the data exchange interface allows connection to the internal components of the EV and access to logs of the internal components, to extract data from the logs and to send the extracted data to servers or cloud, for further analysis.

14. The charging system according to claim 1, further comprising one or more of the following:
a user interface being connected to the charger, for allowing displaying messages to the user and receiving inputs from said user; and
cellular, Wi-Fi or Bluetooth networking capabilities.

15. The charging system according to claim 13, wherein the interface includes a loudspeaker for outputting messages or alerts to the user, a microphone for receiving audio inputs from the user, and biometric sensors for authenticating the identity of the user.

16. (canceled)

17. The charging system according to claim 1, wherein the dedicated software is used for:
transferring storage content between two vehicles; and
copying and moving data to other vehicles or other charging systems.

18. The charging system according to claim 1, wherein the EV is selected from the group of:
electric vehicles;
UAVs;
drones;
electric trucks;
scooters; and
electric bicycles.
